(19) United States
(12) Patent Application Publication
(10) Pub. No.: US 2025/0320813 A1
(43) Pub. Date: Oct. 16, 2025

(54) CALCULATING CAVING VOLUME FOR DRILLING OPERATIONS

(71) Applicant: Landmark Graphics Corporation, Houston, TX (US)

(72) Inventors: Tunc Burak, Houston, TX (US); Robello Samuel, Houston, TX (US); Yongfeng Kang, Houston, TX (US)

(21) Appl. No.: 18/636,692

(22) Filed: Apr. 16, 2024

(51) Int. Cl. E21B 49/00; E21B 44/00

(52) U.S. Cl. CPC E21B 49/006; E21B 2200/20; E21B 2200/22

(57) ABSTRACT

A caving volume or caving probability can be determined by using received user inputs and received subterranean formation characteristics. The portion of the subterranean formation characteristics that represent the rock stresses can be transformed to a coordinate system, such as a cylindrical system. Subterranean formation parameters can be calculated from the transformed characteristics. A lithology-specific algorithm can be applied to the subterranean formation parameters to generate a failure criterion. The caving analysis can then be performed using the subterranean formation parameters. The caving analysis can be performed at incremental radial distance layers into the subterrane formation from a borehole wall. The caving analysis can be performed at various measured depth layers within a depth interval of the borehole where the total caving volume is the total of the individual calculated caving volumes at each measured depth layer.

### TECHNICAL FIELD

This application is directed, in general, to calculating borehole stability and, more specifically, to computing caving volume.

### BACKGROUND

When drilling a borehole, many potential problems can be encountered. Each of these problems needs to be monitored, measured, and reacted to appropriately to improve the efficiency of the drilling operations. Caving of the borehole is one such issue that can be encountered. Conventionally, caving volume has been calculated using a triangle-prism method. The break potential is the modeled triangle-prism-shaped volume. This can lead to inaccurate caving volume calculations. Improving the estimations of caving volumes can be beneficial to improving the efficiency of drilling operations.

### BRIEF DESCRIPTION

Reference is now made to the following descriptions taken in conjunction with the accompanying drawings, in which:

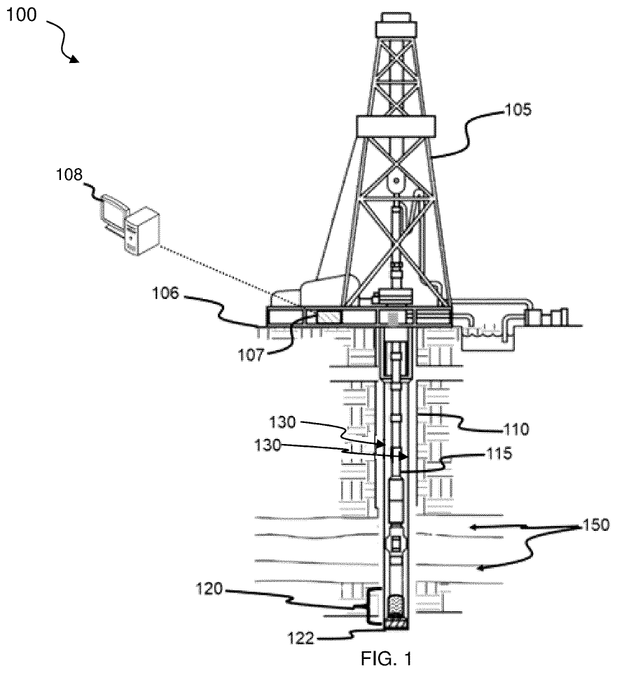

FIG. 1 is an illustration of a diagram of an example drilling system drilling along a planned borehole path;

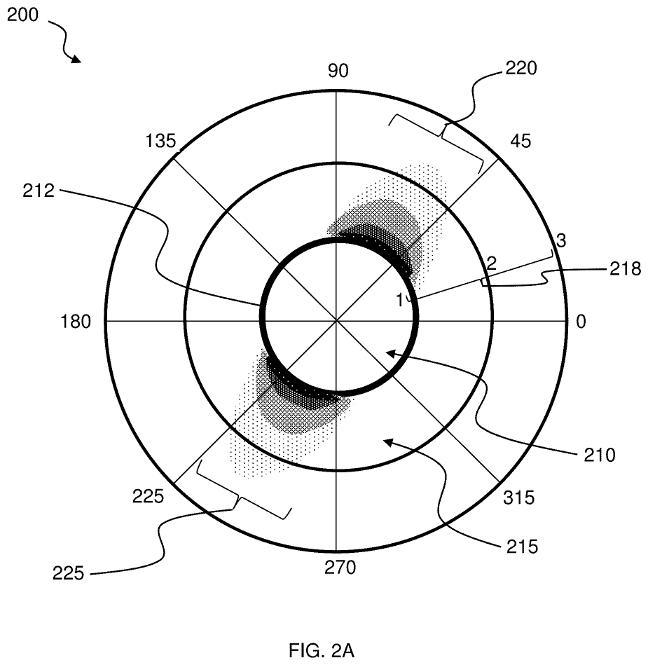

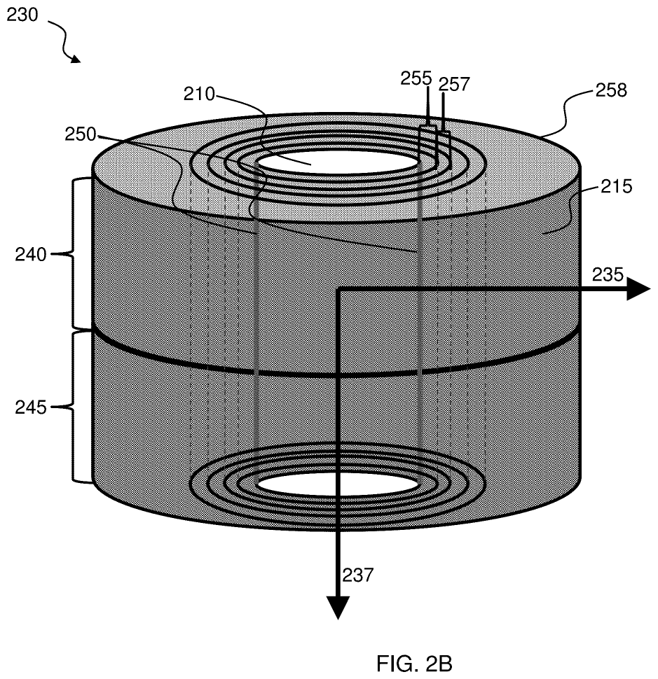

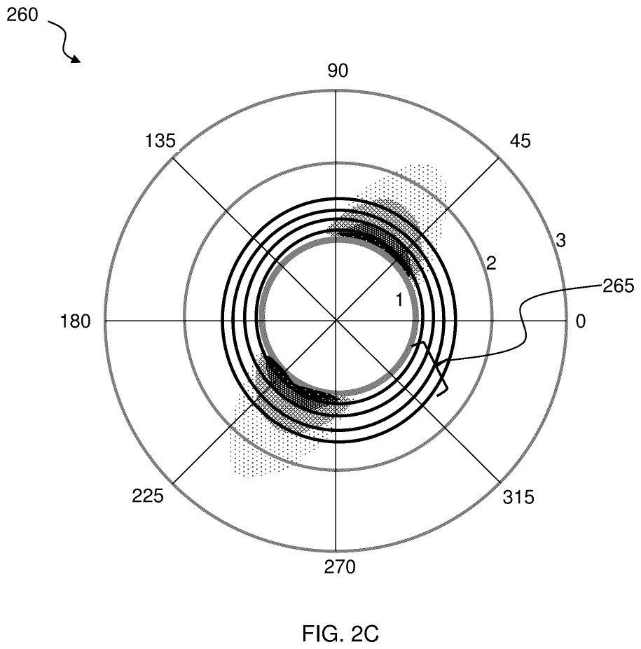

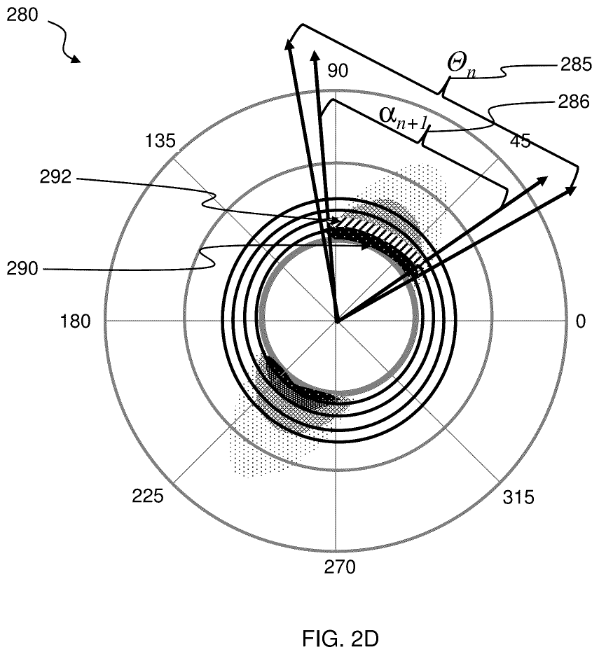

FIG. 2A is an illustration of a diagram of an example radial analysis into a subterranean formation;

FIG. 2B is an illustration of a diagram of an example three-dimensional (3D) visualization 230 of radial distance layers;

FIG. 2C is an illustration of a diagram of an example top view 260;

FIG. 2D is an illustration of a diagram of an example analysis 280;

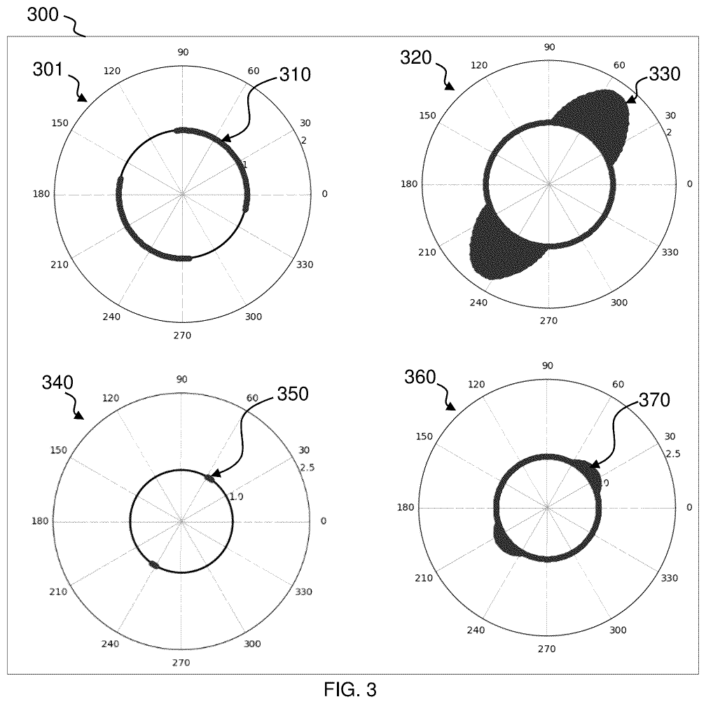

FIG. 3 is an illustration of a comparison diagram of an example caving analysis;

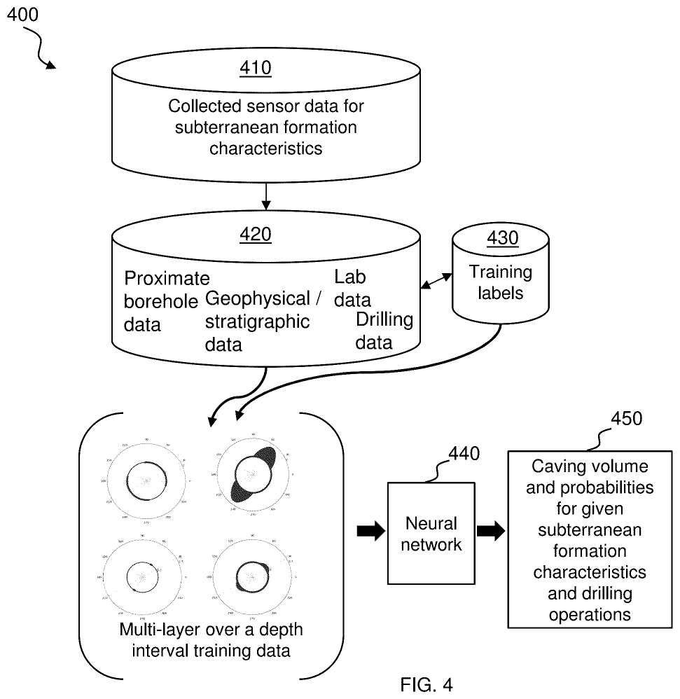

FIG. 4 is an illustration of a diagram of an example caving analysis training flow for training a caving machine learning system;

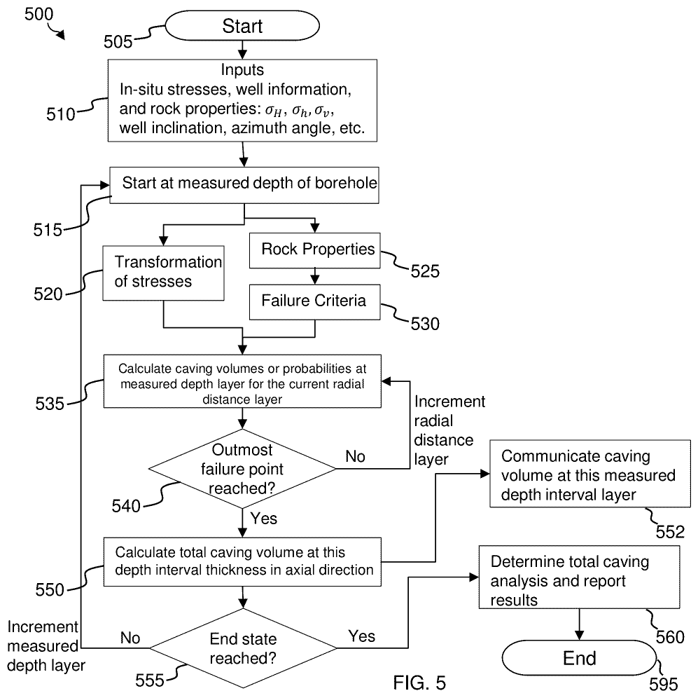

FIG. 5 is an illustration of a flow diagram of an example method to determine a caving volume or a caving probability;

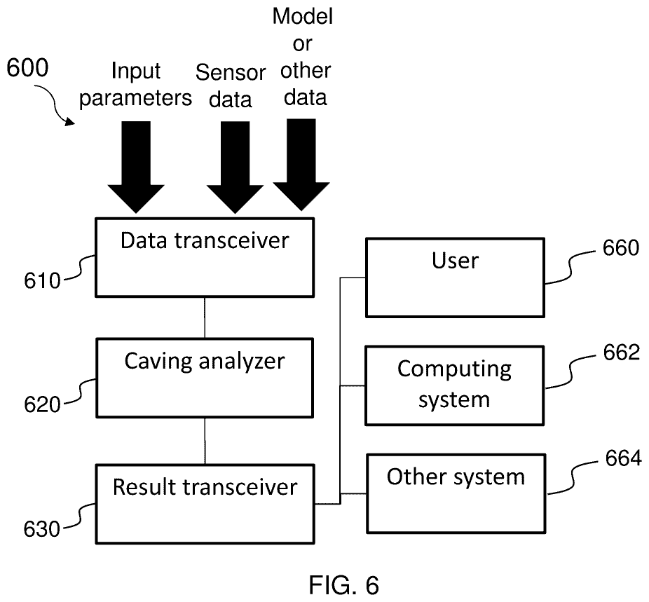

FIG. 6 is an illustration of a block diagram of an example caving analyzer system; and

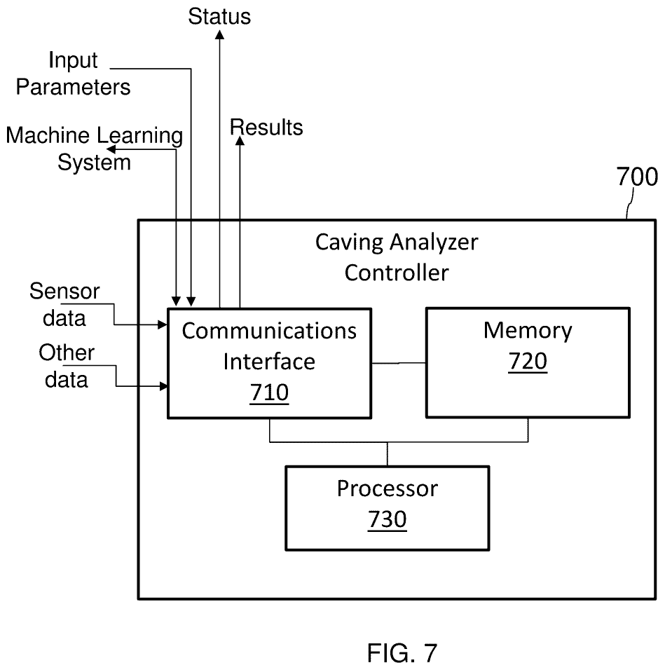

FIG. 7 is an illustration of a block diagram of an example caving analyzer controller according to the principles of the disclosure.

### DETAILED DESCRIPTION

In developing a well system, a borehole path can be planned through a subterranean formation. Difficulty can arise in planning the intended borehole path relative to features of the subterranean formation while minimizing the incidence of caving. Caving can result in hole-cleaning operations, a stuck drill string, or other issues that can reduce the efficiency of drilling the borehole. Reservoirs, strata, sedimentary layers, stratigraphic layers, faults, and other features need to be accounted for. Drilling operation plans, e.g., operation parameters, can be adjusted to improve the efficiency of drilling through the subterranean formation. For example, when drilling through a specific type of stratigraphic layer, the weight-on-bit (WOB), the rotations per minute (RPM), the angle of drilling, and other drilling parameters, can be adjusted to maximize efficiency. The drilling operation plan can include mud composition, mud weight, drilling fluid changes, fluid temperature, fluid pressure, and other fluid-related parameters that can be adjusted depending on the conditions downhole to improve the efficiency of the drilling operations.

Developing the borehole, such as for scientific or hydrocarbon production purposes, can utilize data collected by surface sensors, such as seismic sensors, or downhole sensors, such as sensors located with a drilling system, a drilling assembly, or a bottom hole assembly (BHA) to analyze the borehole to determine if a caving event would occur. The data can be utilized by various borehole systems. For example, a drilling operation system can use the data to adjust one or more drilling parameters at a rig controller (e.g., WOB, RPM, or other parameters of the drill string), a mud pump (e.g., fluid composition, temperature, pressure, or other parameters of the pumped fluid), a geo-steering system (e.g., direction or angle of drilling, or other parameters), a drill bit assembly, other drilling systems such as a well site controller, a reservoir controller, a computer system, or other systems capable of controlling or directing operations at a well site.

This disclosure demonstrates methods and processes for determining a caving volume or a likelihood of caving during a drilling operation of a borehole. Determining the caving volume or likelihood of caving in real-time or near real-time during drilling operations can provide data to the drilling controller (whether a drilling system, a geo-steering system, a drill bit assembly, a rig controller, a mud pump, a well site controller, a computing system, or other system capable of directing drilling operations at the borehole) to improve the efficiency of the drilling operations by adjusting drilling parameters to reduce the likelihood or impact of a caving situation. This can reduce hole-cleaning or stuck drill string issues that can occur during drilling operations. In some aspects, improved accuracy in estimating caving volumes or caving probabilities can be used to reduce incidences of a stuck pipe issue, due to poor hole cleaning or pack-off problems. In some aspects, the output of this process can be used as an input into a stuck pipe or a hole cleaning process, for example, to help determine the amount of overpull force needed on a stuck drill pipe or to determine a pack-off calculation.

The disclosed method and process utilize a lithology-dependent borehole stability model. The analysis can be conducted from the inner surface of the borehole and extending to a specified radius increment of the borehole into the surrounding formation. For example, a borehole of radius R can have a caving analysis conducted up to 3R, 4R, 5R, or other radii increments, e.g., from the inner surface of the borehole extending a radial distance of 3R (or more times, as measured from the center of the borehole) into the subterranean formation.

In some aspects, the analysis can be conducted in iterations, where each iteration uses a radial distance increment of the total radii being analyzed. For example, a radial distance increment can be 0.1R, 0.2R, 0.3R, or another value. In an aspect where the analysis is examining the subterranean formation to a radial distance of 3 times the radius of the borehole, then using a radial distance increment of 0.2R, there would be 10 iterations of calculations and analysis performed (1 iteration at each distance increment of 0.2R, i.e., a radial distance layer, from the radial distance of 1R at borehole wall to the distance of 3R radially oriented into the subterranean formation). In each iteration, the breakout angle can be calculated from the borehole stability analysis. By leveraging the breakout angle data and a series of radial layer-by-layer (each iteration using a distance increment to move to the next radial distance layer) annulus volume calculations in the subterranean formation, the caving volume can provide timely and improved analysis of borehole conditions, thereby facilitating the implementation of proactive measures.

In some aspects, proactive measures can be implemented by a user, for example, directing a change in a drilling parameter or a drilling operation. In some aspects, proactive measures can be implemented by a drilling controller. For example, in some aspects, a mud pump can be directed by the caving system to adjust the fluid composition, temperature, or pressure to reduce the probability of a caving event. In some aspects, a rig controller can be directed to adjust the WOB or RPM. In some aspects, a geo-steering system can be directed to change an angle of drilling. In some aspects, other drilling parameters can be adjusted by one or more other controller types.

The disclosed caving model is correlated to a lithology type and a field type. For example, in aspects where the lithology of the subterranean formation is carbonate, the caving model can apply a Mogi-Coulomb failure criterion. In aspects where the lithology of the subterranean formation is sandstone or shale, the caving model can apply a Mohr-Coulomb failure criterion. Other failure criteria can be utilized with other types of lithologies.

Conventionally, calculating caving volumes can utilize the triangle-prism method where the break volume is modeled as a triangle-prism-shaped volume which can result in inaccurate caving volume calculations. This disclosure utilizes a radial layer-by-layer (e.g., more than one distance layer) approach in a measured depth thickness to overcome this deficiency. For each measured depth thickness layer along the radial distance direction, a calculation through radial distance layer-by-layer annulus volume is performed for that measured depth thickness to obtain the total caving volume for that measured depth thickness layer. Once this measured depth thickness layer is completed, the calculation moves to the next depth interval layer, as indicated in FIG. 5 (see “No” resultant for step 555).

Each iteration of the caving analysis can utilize two segments. In the first segment, the transformation of stress can be performed. This can involve utilizing the vertical stress parameters, the minimum and maximum principal horizontal stress parameters, real-time inclination and azimuth parameters, or the orientation of the maximum horizontal stress parameter. In some aspects, the globally measured stress data can be translated into a Cartesian coordinate system, which can then be converted to a cylindrical coordinate system. Subsequently, the stresses around the borehole can be determined using Kirsch equations. A notable aspect of this model is the ability to calculate stresses several times the radius away from the center of the borehole. In some aspects, to calculate the principal stresses, pore pressure multiplied by Biot's coefficient can be subtracted from the stresses around the borehole since poroelastic analysis is being used.

The second segment can represent the calculation of the subterranean formation parameters. Subterranean formation parameters can be, for example, rock strength, Poisson's ratio, porosity, density, or friction angle. Subterranean formation parameters can be determined from real-time or near real-time data collected at a surface or downhole location, or through established correlations, such as with nearby boreholes. In some aspects, a lithology-specific parameter calculation can be applied. The determined subterranean formation parameters can be further modified by applying the relevant subterranean formation failure criteria. The caving model can identify and select the failure criteria based on the drilled lithology. For example, when drilling sandstone or shale, the Mohr-Coulomb failure criterion can be applied. When drilling carbonate, the Mogi-Coulomb failure criterion can be applied.

In some aspects, the disclosure can perform the caving analysis, and by extension, the borehole stability analysis, at specified depth layers (e.g., measured borehole depths) to calculate the caving volume or probability at measured depth interval thickness layer by layer. At each measured depth layer, the iterative analysis is conducted for each radial distance increment as measured from the center of the borehole. This analysis can start at a specified measured borehole depth and then iterate through each measured depth layer increment until the analysis ends. The starting calculation measured borehole depth to the ending measured borehole depth is a measured depth interval. The process can use a measured depth increment to determine the size of change between each measured depth layer, such as using one inch, one foot, or other measured depth values.

At each measured depth layer, the break angle can be calculated utilizing the in-situ stress status and the failure criteria to improve the volume calculation at that measured depth layer thickness. In some aspects, in that measured depth layer, the calculation of caving volume can stop at a radial distance layer where the break-out angle results in a zero (0) value, which means that there is no further failure so no further calculated caving event needed in the subterranean formation. In some aspects, the analysis can end when a specified radial borehole distance is reached or when the drilling operation plan so specifies. In some aspects, the analysis can stop when a specified measured depth layer is reached or exceeded (i.e., a maximum depth layer). Then the volumes previously calculated for each radial distance layer into the subterranean formation for each measured depth layer in the depth interval can be added together to obtain the caving volume for that measured depth interval.

In determining the subterranean formation stresses and transformations, conventional methods can be used. For example, the following conventional equations can be utilized. Since these are conventional equations, further explanations can be found in Li, et al in the references.

$$Conventional stress transformations$$

$${σ}_{x} = ( {σ}_{H} {cos}^{2} α + {σ}_{h} {cos}^{2} α ) {cos}^{2} i + {σ}_{v} {sin}^{2} i {σ}_{y} = {σ}_{H} {sin}^{2} α + {σ}_{h} {cos}^{2} α {σ}_{z} = ( {{σ}_{H}}_{} {cos}^{2} α + {σ}_{h} {sin}^{2} α ) {sin}^{2} i + {σ}_{v} {cos}^{2} i {σ}_{x y} = \frac{1}{2} ( {σ}_{h} - {σ}_{H} ) sin 2 α \cdot cos i \\ {σ}_{y z} = \frac{1}{2} ( {σ}_{h} - {σ}_{H} ) sin 2 α \cdot sin i \\ {σ}_{x z} = \frac{1}{2} ( {σ}_{H} {cos}^{2} α + {σ}_{h} * {sin}^{2} α - {σ}_{v} ) sin 2 i \qquad Equation Set 1$$

where:
σ_{H} is the maximum horizontal principal stress,
σₕ is the minimum horizontal principal stress,
σᵥ is the vertical principal stress,
σₓ is the normal stress along the x-axis,
σ_{y} is the normal stress along the y-axis,
σ_{z} is the normal stress along the z-axis,
σ_{xy} is the shear stress on the x-plane along the y-direction,
σ_{yz} is the shear stress on the y-plane along the z-direction,
σ_{xz} is the shear stress on the x-plane along the z-direction,
α is the drilling direction with respect to σ_{H}, and
i is the well inclination angle.

The following equations can be used to calculate the stresses around the vicinity of the borehole and up to n times of radii away from the center point of the borehole into the subterranean formation radially. In some aspects, the analysis can be performed using stresses that are calculated for each theta (θ) angle of 0.0 to 180.0 degrees (e.g., a restricted set of angles). To decrease computational resources, stresses can be calculated from 0.0 to 180.0 degrees, and apply direct symmetry on the opposite side of the borehole.

$$Calculating stress es at a distance layer for a radius r from the \\ well center in the formation$$

$${σ}_{r} = \frac{{σ}_{x} + {σ}_{y}}{2} ( 1 - \frac{{R}^{2}}{{r}^{{}_{2}}} ) + \frac{{σ}_{x} - {σ}_{y}}{2} ( 1 - \frac{4 {R}^{2}}{{r}^{{}_{2}}} + \frac{3 {R}^{4}}{{r}^{{}_{4}}} ) cos 2 θ + {σ}_{x y} ( 1 - \frac{4 {R}^{2}}{{r}^{{}_{2}}} + \frac{3 {R}^{4}}{{r}^{{}_{4}}} ) sin 2 θ + \frac{{P}_{w} {R}^{2}}{{r}^{{}_{2}}} \\ {σ}_{θ} = \frac{{σ}_{x} + {σ}_{y}}{2} ( 1 + \frac{{R}^{2}}{{r}^{{}_{2}}} ) - \frac{{σ}_{x} - {σ}_{y}}{2} ( 1 + \frac{3 {R}^{4}}{{r}^{{}_{4}}} ) cos 2 θ - {σ}_{x y} ( 1 + \frac{3 {R}^{4}}{{r}^{{}_{4}}} ) sin 2 θ - \frac{{P}_{w} {R}^{2}}{{r}^{{}_{2}}} \\ {σ}_{z} = {σ}_{z}^{0} - 2 v ( {σ}_{x} - {σ}_{y} ) \frac{{R}^{2}}{{r}^{{}_{2}}} cos 2 θ - 4 v {σ}_{x y} \frac{{R}^{2}}{{r}^{{}_{2}}} sin 2 θ \\ {τ}_{r θ} = ( \frac{{σ}_{x} - {σ}_{y}}{2} sin 2 θ + {σ}_{x y} cos 2 θ ) ( 1 + \frac{2 {R}^{2}}{{r}^{{}_{2}}} - \frac{3 {R}^{4}}{{r}^{{}_{4}}} ) \\ {τ}_{r z} = ( {σ}_{y z} sin θ + {σ}_{x z} cos θ ) ( 1 - \frac{{R}^{2}}{{r}^{{}_{2}}} ) \\ {τ}_{θ z} = ( - {σ}_{x z} sin θ + {σ}_{y z} cos θ ) ( 1 + \frac{{R}^{2}}{{r}^{{}_{2}}} ) \qquad Equation Set 2$$

where:
σᵣ is the radial stress in the near field,
σ_{θ} is the tangential stress in the near field,
σ_{z} is the axial stress in the near field along the well axis,
τ_{rθ} is the shear stress on the r-plane along the θ-direction,
τ_{rz} is the shear stress on the r-plane along the z-direction,
τ_{θz} is the shear stress on the θ-plane along the z-direction,
σₓ is the normal stress along the x-axis,
σ_{y} is the normal stress along the y-axis,
σ_{z}⁰ is the normal stress along the z-axis,
σ_{xy} is the shear stress on the x-plane along the y-direction,
σ_{yz} is the shear stress on the y-plane along the z-direction,
σ_{xz} is the shear stress on the x-plane along the z-direction,
R is the radius of the borehole,
r is the radial distance in the near field from the well center,
θ is the angle measured clockwise from the x-axis,
P_{w} is the pressure in the borehole, and
v is Poisson's ratio.

To calculate the in-situ stresses from the borehole wall (1 radius from the center of the borehole) to the specified radial distance into the subterranean formation (n times the radius of the borehole, such as 3, 4, or 5), the iteration can change the radial distance analyzed into the subterranean formation by the distance increment, for example, 0.2 of the radius each iteration until the maximum specified distance into the subterranean formation is reached or a 0 break out angle is reached. In some aspects, each iteration can apply the borehole stability analysis by applying the Mogi-Coulomb, Mohr-Coulomb, or other failure criteria (e.g., a lithology-specific algorithm) to the previously calculated stresses.

$$Applying the Mogi - Coulom b failure criterion for carbonate lithology$$

$${τ}_{oct} = a + b * {σ}_{m 2} \\ where , \\ {τ}_{oct} = \frac{1}{3} \sqrt{{( {σ}_{1} - {σ}_{2} )}^{2} + {( {σ}_{2} - {σ}_{3} )}^{2} + {( {σ}_{1} - {σ}_{3} )}^{2}} \\ {σ}_{m 2} = \frac{( {σ}_{1} + {σ}_{3} )}{2} \\ a = \frac{2 \sqrt{2} * UCS}{3 * ( q + 1 )} and b = \frac{2 \sqrt{2} * ( q - 1 )}{3 * ( q + 1 )} \\ q = \frac{1 + sin ( friction angle )}{1 - sin ( friction angle )} \\ Failure eqn ( F ) = a + b {σ}_{m 2} - {τ}_{oct} and when F \leq 0 there will be a shear failure . \qquad Equation Set 3$$

$$Applying the Mohr - Coulom b failure criterion for sandstone or shale lithology$$

$${σ}_{1} = q * {σ}_{3} + UCS \\ Failure eqn ( F ) = q * {σ}_{3} + UCS - {σ}_{1} and when F \leq 0 there will be a shear failure . \qquad Equation Set 4$$

where, for Equation Set 3 and Equation Set 4:
τ_{oct} is the octahedral shear stress,
σₘ₂ is the effective mean stress,
σ₁ is the maximum principal stress,
σ₂ is the intermedia principal stress,
σ₃ is the minimum principal stress,
q is the slope of the line relating to σ₁ and σ₃,
a is the Mogi parameter,
b is the Mogi parameter, and
UCS is the Uniaxial compressive strength of the formation.

Equation Set 3 and Equation Set 4 can be applied at a measured depth layer, iterating through the radial distance layers from the borehole wall to the specified maximum distance from the well center in radial direction for the measured depth layer thickness. This analysis can be performed at more than one measured depth layer within the measured depth interval. To perform this calculation, the breakout angle can be determined in each iteration using Equation Set 3 or 4, or other failure criteria. In some aspects, if not otherwise specified, the measured depth increment in the measured depth layer-by-layer analysis can be set to one inch or one foot. Calculations can be carried out around half of the borehole using direct symmetry to project results for the non-analyzed half of the borehole to reduce computing time. Therefore the caving volume on one side (180 degrees) can be multiplied by two to obtain the total caving volume of the 360-degree region in this measured depth layer thickness.

$${Area}_{a n n u l u {s}_{n}} = π * ( formation radial layer {radius}_{n}^{2} - formation radial layer {radius}_{n - 1}^{2} ) \\ {V}_{a n n u l u {s}_{n}} = {Area}_{a n n u l u {s}_{n}} * ( measured depth layer thickness ) \\ ( Caving volume on one side in radial layer n ) = {V}_{a n n u l u {s}_{n}} * \frac{breakout {angle}_{n}}{360} \\ Total caving volume at Depth layer = {\sum }_{( Well radius )}^{( Well radius ) * n} [ 2 * ( Caving Volume on one side in radial layer n ) - 2 * porosity * ( Caving Volume on one side in radial layer n ) ] \qquad Equation Set 5$$

In some aspects, a caving machine learning system can be utilized to perform one or more steps of the analysis. This can achieve an improved predictive performance by training machine learning models to estimate potential caving volumes or caving probabilities using the subterranean formation characteristics as input data. In some aspects, the caving machine learning system can be part of a caving analyzer, caving processor, or a drilling controller, such as a drilling system, a rig controller, a mud pump, a well site controller, a computing system, or other system capable of controlling drilling operations, such as geo-steering system. In some aspects, the caving machine learning system can be part of a computing system located proximate to the borehole, an edge system, a cloud environment, a data center, a laboratory, a server, or a corporate environment.

In some aspects, the caving machine learning system can automatically generate the caving volume or caving probability using the input parameters and communicate the results to another system that can then use that information as input data for its processing, such as to adjust drilling parameters, to adjust mud pumps, or to adjust other drilling operations to reduce caving volumes or probabilities.

Turning now to the figures, FIG. 1 is an illustration of a diagram of an example drilling system 100 drilling along a planned borehole path, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105, a well site controller 107, and a computing system 108. Well site controller 107 includes a processor and a memory and is configured to direct the operation of drilling system 100. Derrick 105 is located at a surface 106.

Extending below derrick 105 is a borehole 110 with downhole tools 120 at the end of a drill string 115. Downhole tools 120 can include various downhole tools, such as a formation tester or a bottom-hole assembly (BHA). Downhole tools 120 can include a seismic tool or an ultra-deep seismic tool. At the bottom of downhole tools 120 is a drilling bit 122. Other components of downhole tools 120 can be present, such as a local power supply (e.g., generators, batteries, or capacitors), telemetry systems, sensors, transceivers, and control systems. Borehole 110 is surrounded by subterranean formation 150.

Well site controller 107 or computing system 108 which can be communicatively coupled to well site controller 107, can be utilized to communicate with downhole tools 120, such as sending and receiving acoustic data, seismic data, telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various conventional means, now known or later developed, with computing system 108 or well site controller 107. Well site controller 107 or computing system 108 can communicate with downhole tools 120 using conventional means, now known or later developed, to direct operations of downhole tools 120, e.g., geo-steering operations. Casing 130 can act as barrier between subterranean formation 150 and the fluids and material internal to borehole 110, as well as drill string 115.

In some aspects, sensor data can be collected using sensors located at surface 106. In some aspects, sensor tools can collect sensor data relating to the subterranean formation where the sensor tools are positioned downhole the borehole or a nearby borehole. In some aspects, sensor data can include the subterranean formation characteristics (e.g., characteristics about the stratigraphy, the geology, composition, porosity, density, or other characteristics of the formation). In some aspects, the sensor tools can be seismic sensors, ultra-deep seismic sensors, nuclear magnetic resonance sensors, acoustic sensors, electrical sensors, or other sensor types now known or later developed for borehole use.

In some aspects, a caving analyzer can utilize the sensor data to generate a potential caving volume or caving probability. In some aspects, the caving analyzer can communicate the collected data or the results to another system, such as computing system 108 or well site controller 107 where the data can be filtered and analyzed. In some aspects, computing system 108 can be the caving analyzer and can receive the sensor data from one or more of the sensor tools. In some aspects, well site controller 107 can be the caving analyzer and can receive the sensor data from one or more of the sensor tools. In some aspects, the caving analyzer can be partially included with well site controller 107 and partially located with computing system 108.

The caving result output from the caving analyzer can be used to direct operations of drilling system 100, such as to update or modify the planned borehole path, such as communicating to a drilling controller. For example, a drilling controller can be one or more types of controllers or systems at the well site. In some aspects, the drilling controller can be a geo-steering system where directions to downhole tools 120 can include geo-steering instructions so that future drilling operations are along the planned or intended borehole path. In some aspects, the drilling controller can be a mud pump where directions can be communicated to a mud pump at drilling system 100 to modify a drilling fluid parameter, such as modifying a composition, a temperature, or a pressure of the fluid. In some aspects, the drilling controller can be a rig controller where directions can be communicated to a rig controller proximate derrick 105, for example, to modify a WOB or RPM of the drill string. A rig controller can be, for example, a top drive controller that directs a top drive. In some aspects, the drilling controller can be a well site controller where directions can be communicated to a well site controller to update a drilling operation plan or modify other drilling operation parameters. The drilling controller can be a top drive controller that directs a top drive

FIG. 1 depicts onshore operations. Those skilled in the art will understand that the disclosure is equally well suited for use in offshore operations. FIG. 1 depicts a specific borehole configuration, those skilled in the art will understand that the disclosure is equally well suited for use in boreholes having other orientations including vertical boreholes, horizontal boreholes, slanted boreholes, multilateral boreholes, and other borehole types.

FIG. 2A is an illustration of a diagram of an example radial analysis 200 into a subterranean formation. Radial analysis 200 is a top-down cross-section view of a borehole 210 showing how the radial distance layer by distance layer analysis can be represented using a visual method. Radial analysis 200 shows relative caving volumes that can potentially occur under a current drilling operation plan. Borehole 210 is surrounded by an inner surface 212 of a subterranean formation 215. In this example, a radius of interest 218 is 3R, meaning the analysis of radial distance layer by distance layer is conducted in radial distance increments extending a distance of 3 times the radius of borehole 210 into subterranean formation 215. The analysis begins at inner surface 212 and ends at a radius of 3R, where R is the radius of the borehole.

An arbitrary starting point has been determined to represent the 0° mark on the radial coordinates. The analysis can cover 0.0° to 180.0° radially, as shown using the top-down perspective of radial analysis 200. The break-out angle between approximately 30° and 90° of radial analysis 200 can be represented by the caving analysis shown as caving volumes 220. The breakout angle for each annulus layer can be calculated, so the caving volume in that annular layer can be calculated using Equation Set 5. Adding up all the layers of annulus caving volume, the total caving volume on one-half of the circumference of the borehole can obtained within the measured depth layer thickness. A caving volumes 225 is shown as a direct symmetry from caving volumes 220. Caving volumes 225 do not need to be directly calculated, rather they can be determined using direct symmetry to reduce computing time for faster response times.

FIG. 2B is an illustration of a diagram of an example three-dimensional (3D) visualization 230 of radial distance layers at two proximate measured depth layers. 3D visualization 230 shows radial analysis 200 oriented vertically using a 3D perspective of subterranean formation 215. 3D visualization shows two measured depth layers, a measured depth layer 240 and a measured depth layer 245. A radial distance vector is shown using vector 235 (i.e., radial axis). A measured depth layer vector is shown by vector 237 (i.e., axial axis). Measured depth layer 240 is a measured depth layer thickness of k, and measured depth layer 245 is a measured depth layer thickness of k+1.

Borehole 210 has a borehole wall 250 (e.g., inner surface) extending through subterranean formation 215. A first radial distance layer 255 is indicated by the area delineated between the two concentric circles. A second radial distance layer 257 is indicated by the area delineated between the larger of the previous concentric circles and one larger concentric circle. First radial distance layer 255 can be the n^{th} radial distance layer and second radial distance layer 257 can be the n^{th}+1 radial distance layer. The thickness of each of first radial distance layer 255 and second radial distance layer 257 are determined from the radial distance increment parameter, for example, expressed in terms of borehole 210 radius R, (e.g., 0.2R). An outer boundary 258 is shown, such as being 3R, or another value, in radius.

FIG. 2C is an illustration of a diagram of an example top view 260. Top view 260 is a top-down view of the distance layers as shown in 3D visualization 230, arrayed on the radial diagram of radial analysis 200. The radial distance layers, such as first radial distance layer 255 and second radial distance layer 257 form a group of radial distance layers 265.

FIG. 2D is an illustration of a diagram of an example analysis 280. Analysis 280 builds on radial analysis 200 and top view 260. Analysis 280 demonstrates a first breakout angle 285 which is an angle θ at the n^{th} radial distance layer. A second breakout angle 286 is shown with an angle α at the n^{th}+1 radial distance layer. First breakout angle 285 and second breakout angle 286 can each be a restricted set of angles. The restricted set of angles utilize vectors that originate from the center point of the borehole and are perpendicular to the inner surface of the borehole. A caving volume 290 is shown within the radial distance layer n, and a caving volume 292 is shown within the radial distance layer n+1 on a measured depth layer thickness.

FIG. 3 is an illustration of a comparison diagram of an example caving analysis 300. Caving analysis 300 utilizes a similar polar coordinate system as shown in FIG. 2A. Each coordinate plot represents the same drilling and downhole conditions with the exception that the top two coordinate plots represent shale rock characteristics and the bottom two coordinate plots represent carbonate rock characteristics.

A coordinate plot 301 is an example of a caving volume 310 at a measured depth layer of 2,600 feet within the borehole in a shale-type subterranean formation. A coordinate plot 320 is an example of a caving volume 330 at a measured depth layer of 5,400 feet within the borehole in a shale-type subterranean formation. The depths analyzed between 2,600 to 5,400 feet form the depth interval.

A coordinate plot 340 is an example of a caving volume 350 at a measured depth layer of 2,600 feet within the borehole in a carbonate-type subterranean formation. A coordinate plot 360 is an example of a caving volume 370 at a measured depth layer of 5,400 feet within the borehole in a carbonate-type subterranean formation. Using the same scale for each coordinate plot, the total caving volume for the shale analysis can be larger than the caving volume for the carbonate analysis. The reflected direct symmetry caving volumes are also represented on each respective coordinate plot.

FIG. 4 is an illustration of a diagram of an example caving analysis training flow 400 for training a caving machine learning system. Caving analysis training flow 400 can be used to train a machine learning system using one or more machine learning models of the caving analysis processes. A data store 410 can receive the sensor data collected from one or more sensors or sensor tools located downhole or a surface location proximate to the borehole. Data store 410 can receive drilling parameters being used for the drilling operation, for example, WOB, RPM, mud composition, mud temperature, mud pressure, drilling angle, or other drilling parameters.

In a process 420, the received sensor data can be transformed to an appropriate coordinate system, such as a cylindric or polar coordinate system. Process 420 can receive data from sources other than the current borehole. For example, data can be received from a proximate borehole, from geophysical data sources, stratigraphic data sources, laboratory data, corporate data, or drilling operation data for the current or other boreholes.

In a process 430, the sensor data can be labeled for training the machine learning models. The training label can be obtained from legacy interpretation, user operation, label fusion, or using a cross-validation workflow. The trained machine learning models can be used to process the sensor data in a process 440 to generate a caving analysis result for each distance layer, such as an estimate of a caving volume or a caving probability. In a process 450, the caving analysis result for the depth interval being analyzed can be produced by combing the caving volumes or caving probabilities for each distance layer (distance layers into the subterranean formation) and each measured depth layer of the borehole in a depth interval from process 440 using a weighting algorithm. The resulting caving learning machine model can be used with other collected sensor data of subterranean formation characteristics and drilling operation parameters to estimate a caving volume or a caving probability. This output can then be used as inputs into another process, such as to modify the drilling operation plan, modify a mud pump operation, modify a rig controller parameter, modify a downhole drilling assembly parameter, modify a geo-steering parameter, or modify other controller or drilling operation parameters.

FIGS. 2-4 demonstrate a partial visual display of the caving analysis. In some aspects, the visual display can be utilized by a user to determine the next steps of the analysis. In some aspects, the visual display does not need to be generated, and a system, such as a machine learning system, can perform the analysis using the received data. In some aspects, a visual display and a machine learning system can be utilized. In some aspects, the analysis of the sensor data can occur by a downhole tool, such as a geo-steering tool or a BHA. In some aspects, the sensor data can be transmitted to one or more surface computing systems, such as a well site controller, a computing system, a cloud environment, a data center, a laboratory, an edge computing system, or other processing system. The surface system or surface systems can perform the analysis and communicate the results to one or more other systems, such as a data store, a corporate system, a reservoir controller, a well site controller, a well site operation planner, a geo-steering system, a rig controller, a mud pump, or another borehole system.

FIG. 5 is an illustration of a flow diagram of an example method 500 to determine a caving volume or a caving probability. Method 500 can be performed on a computing system, for example, caving analyzer system 600 of FIG. 6 or caving analyzer controller 700 of FIG. 7. The computing system can be a well site controller, a reservoir controller, a geo-steering system, a rig controller system, a drilling controller, a data center, a cloud environment, a server, a laptop, an edge computing system, a mobile device, a smartphone, a PDA, or other computing system capable of receiving the sensor data, input parameters, and capable of communicating with other computing systems. Method 500 can be encapsulated in software code or in hardware, for example, an application, code library, dynamic link library, module, function, RAM, ROM, and other software and hardware implementations. The software can be stored in a file, database, or other computing system storage mechanism. Method 500 can be partially implemented in software and partially in hardware. Method 500 can perform the steps for the described processes, for example, using a machine learning system for determining an estimated caving volume given the subterranean formation characteristics and the drilling operation plan.

Method 500 starts at a step 505 and proceeds to a step 510. In step 510, the inputs are received. The inputs can be system or user parameters, for example, a starting measured depth within the borehole, a depth interval, a depth increment, a radial distance to analyze into the subterranean formation at each measured depth layer (e.g., the n times radius), a machine learning model to utilize, a distance increment to use for the radial distance layer by distance layer analysis from the inner surface of the borehole to the maximum specified distance into the subterranean formation, or other input parameters.

The inputs can be the sensor data collected from surface sensors or downhole sensors at the borehole. The sensor data represents the subterranean formation characteristics at the location where the sensor collects the data. In some aspects, the sensor data received can be in real-time or near real-time so that the caving analysis can be performed while drilling operations are ongoing. In some aspects, the inputs can be a machine learning model, training model, or other data model to be used with the caving analysis or to receive the results of the caving analysis. In some aspects, the inputs can be other data sources, such as geophysical data, stratigraphic data, sensor data previously collected at the current borehole (e.g., previous sensor collection), sensor data collected at proximate boreholes, laboratory data, or other data sources.

In a step 515, the caving analysis process begins at the designated starting measured depth of the borehole. The sensor data correlating to the starting measured depth is analyzed. Method 500 proceeds to a step 520 and a step 525. In step 520, the portion of the sensor data that represents the rock stresses of the subterranean formation characteristics can be transformed to one or more coordinate systems, such as a Cartesian coordinate system, a polar coordinate system, or a cylindric coordinate system (e.g., generating transformed subterranean formation characteristics by transforming the received subterranean formation characteristics). This transformation allows for the subsequent analysis to be performed using the coordinate system. Method 500 proceeds to a step 535.

In step 525, rock properties are extracted from the subterranean formation characteristics. For example, an identification can be made between shale or sandstone type of rock, carbonate type of rock, or other category of rock. In a step 530, the failure criterion can be determined from the rock type, such as using the Mohr-Coulomb or Mogi-Coulomb failure criterion. Method 500 proceeds to a step 535.

Once step 520 and step 530 have been completed, method 500 proceeds to step 535 where, starting at the inner surface of the borehole at a measured depth layer interval thickness (starting at the starting measured depth), a radial distance layer analysis is conducted of the borehole stability and a caving volume or a caving probability for that radial distance layer can be determined. The radial distance layer analysis can be conducted by a machine learning system, such as applying a learned model to the sensor data and the drilling parameters to determine the results.

In a decision step 540, a determination is made whether the current radial distance layer being analyzed is at the maximum distance layer into the subterranean formation. Other end states can be used as well, for example, is the caving volume for the last radial distance layer zero (which means that the borehole is likely to be stable and no further caving is predicted). If the resultant is “No”, then the layer distance is incremented by the radial distance increment (for example, 0.2R), and then the next radial distance layer into the subterranean formation in this measured depth layer is analyzed in step 535. If the resultant is “Yes”, then method 500 proceeds to a step 550.

In step 550, the total caving volume or caving probability is calculated at the current measured depth layer. In a step 552, the caving volume at this measured depth layer can be communicated, such as in real-time, near real-time, batch, or other type of reporting time frame. The calculated results can be used for adjustment of drilling parameters.

In a decision step 555, a determination is made whether an end state has been reached. For example, an end state can be that the total depth interval has been analyzed, or the drilling operation specifies an end to the caving analysis. If the resultant is “No”, then the measured depth layer is incremented to the next measured depth layer using the depth increment. Method 500 proceeds to step 515 to perform the caving analysis radial distance layer by distance layer into the subterranean formation at the new measured depth layer. If the resultant is “Yes”, then method 500 proceeds to a step 560.

In a step 560, the caving results are calculated. For caving volume, the total caving volume is an addition of each caving volume calculated at each measured depth interval. For total caving probability, the caving probability determined at each measured depth layer and each radial distance layer is an algorithmic combination, such as an average, a mean, a median, a weighted combination, or other mathematical algorithm. The results, e.g., the caving volume or the caving probability, can be communicated to one or more users, user systems, drilling controllers, borehole controllers, or other computing systems. The results can be used as inputs into other processes, such as to modify drilling operations in a drilling controller.

The results can be used, for example, by a geo-steering system to update a planned borehole path to be drilled by a drilling system, by a reservoir controller or well site controller to modify a planned borehole path, by a drilling controller to modify drilling parameters (e.g., WOB, RPM, mud composition, mud temperature, mud pressure, drill bit parameters, drilling angle, drilling direction, or other drilling parameters), or by other systems, such as corporate systems, edge computing systems, data centers, cloud environments, or other computing systems to update drilling operation plans or to update machine learning models. Method 500 ends at a step 595.

FIG. 6 is an illustration of a block diagram of an example caving analyzer system 600. Caving analyzer system 600 can be implemented in one or more computing systems, for example, a data center, a cloud environment, a server, a laptop, a smartphone, a tablet, an edge computing system, a laboratory system, or other computing systems. In some aspects, caving analyzer system 600 can be implemented using a caving analyzer controller such as caving analyzer controller 700 of FIG. 7. Caving analyzer system 600 can implement one or more methods of this disclosure, such as method 500 of FIG. 5.

Caving analyzer system 600, or a portion thereof, can be implemented as an application, a code library, a dynamic link library, a function, a module, other software implementation, or combinations thereof. In some aspects, caving analyzer system 600 can be implemented in hardware, such as a ROM, a graphics processing unit, or other hardware implementation. In some aspects, caving analyzer system 600 can be implemented partially as a software application and partially as a hardware implementation. Caving analyzer system 600 is a functional view of the disclosed processes and an implementation can combine or separate the described functions in one or more software or hardware systems.

Caving analyzer system 600 includes a data transceiver 610, a caving analyzer 620, and a result transceiver 630. The caving results, e.g., the caving volume or caving probability, and interim outputs from caving analyzer 620 can be communicated to a data receiver, such as one or more of a user or user system 660, a computing system 662, or other processing or storage systems 664. The caving results can be used to determine modifications to the drilling operations to reduce the risk of caving or to reduce the caving volume. The caving results can be communicated to one or more drilling controllers, such as a rig controller to adjust WOB, a mud pump to adjust the composition, temperature, or pressure of drilling fluid, a drilling assembly to adjust an angle of drilling or an RPM, a geo-steering system to adjust the operation of a drilling assembly or drill bit, or other borehole controller. The drilling controller can be a well site controller, a reservoir controller, a drilling controller, a BHA, a drilling assembly, or other controllers.

Data transceiver 610 can receive input parameters, such as parameters to direct the operation of the analysis implemented by caving analyzer 620, such as algorithms to utilize in determining how to determine the caving volume, a distance increment to utilize, a distance to use into the subterranean formation (e.g., the n times the borehole radii value, such as 3R), a measured depth interval, a measured depth increment, a starting depth, a machine learning model to use in the analysis, or other input parameters, such as zero or more other data sources to use (e.g., geophysical, stratigraphic, proximate boreholes, laboratory, or other data sources). Data transceiver 610 can receive sensor data collected with surface or downhole sensors where the sensor data represents subterranean formation characteristics within the previously specified n times radius distance of the center of the borehole. In some aspects, data transceiver 610 can be part of caving analyzer 620.

Result transceiver 630 can communicate one or more results, analysis, or interim outputs, to one or more data receivers, such as user or user system 660, computing system 662, storage system 664, e.g., a data store or database, or other related systems, whether located proximate result transceiver 630 or distant from result transceiver 630. Computing system 662 can be one or more drilling operation controllers. Storage system 664 can be a machine learning training system or a machine learning model system.

Data transceiver 610, caving analyzer 620, and result transceiver 630 can be, or can include, conventional interfaces configured for transmitting and receiving data. In some aspects, caving analyzer 620 can be a machine learning system, such as providing a process to analyze sensor data and drilling operation plans by using computational methods to estimate a caving volume or caving probability over a measured depth interval.

Caving analyzer 620 can implement the analysis and algorithms as described herein utilizing the sensor data, the input parameters, and optionally the machine learning model data or other data sources. For example, caving analyzer 620 can perform the analysis of the sensor data to compute a caving volume or a caving probability.

A memory or data storage of caving analyzer 620 can be configured to store the processes and algorithms for directing the operation of caving analyzer 620. Caving analyzer 620 can include a processor that is configured to operate according to the analysis operations and algorithms disclosed herein, and an interface to communicate (transmit and receive) data.

FIG. 7 is an illustration of a block diagram of an example caving analyzer controller 700 according to the principles of the disclosure. Caving analyzer controller 700 can be stored on a single computer or multiple computers. The various components of caving analyzer controller 700 can communicate via wireless or wired conventional connections. A portion or a whole of caving analyzer controller 700 can be located at one or more locations and other portions of caving analyzer controller 700 can be located on a computing device or devices located at a surface location. In some aspects, caving analyzer controller 700 can be wholly located at a surface or distant location. In some aspects, caving analyzer controller 700 can be part of another system, and can be integrated in a single device, such as a part of a borehole operation planning system, a drilling controller, a reservoir controller, a corporate system, a data center, a cloud environment, an edge computing system, a well site controller, a geo-steering system, or other borehole systems or controllers.

Caving analyzer controller 700 can be configured to perform the various functions disclosed herein including receiving input parameters, sensor data machine learning models, or other data, and generating results from an execution of the methods and processes described herein, such as estimating a caving volume or a caving probability, and other results and analysis. Caving analyzer controller 700 includes a communications interface 710, a memory 720, and a processor 730.

Communications interface 710 is configured to transmit and receive data. For example, communications interface 710 can receive the input parameters, sensor data, other data, or machine learning models. Communications interface 710 can transmit the generated caving results or interim outputs. In some aspects, communications interface 710 can transmit a status, such as a success or failure indicator of caving analyzer controller 700 regarding receiving the various inputs, transmitting the generated feature results, or producing the generated caving results.

In some aspects, communications interface 710 can receive input parameters from a machine learning system, for example, where the sensor data is processed against learned models to improve the caving volume or caving probability estimation.

In some aspects, the machine learning system can be implemented by processor 730 and perform the operations as described by caving analyzer 620. Communications interface 710 can communicate via communication systems used in the industry. For example, wireless or wired protocols can be used. Communication interface 710 is capable of performing the operations as described for data transceiver 610 and result transceiver 630 of FIG. 6.

Memory 720 can be configured to store a series of operating instructions that direct the operation of processor 730 when initiated, including the code representing the algorithms for determining processing the collected data. Memory 720 is a non-transitory computer-readable medium. Multiple types of memory can be used for data storage and memory 720 can be distributed.

Processor 730 can be configured to produce the generated caving results (e.g., estimated caving volume or caving probability, and other results), one or more interim outputs, and statuses utilizing the received inputs. For example, processor 730 can analyze sensor data at more than one measured depth layer to estimate a caving volume over a depth interval. Processor 730 can be configured to direct the operation of caving analyzer controller 700. Processor 730 includes the logic to communicate with communications interface 710 and memory 720, and perform the functions described herein. Processor 730 is capable of performing or directing the operations as described by caving analyzer 620 of FIG. 6.

A portion of the above-described apparatus, systems, or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate array (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Aspects disclosed herein include:
A. A method, including (1) receiving input parameters for a subterranean formation proximate a borehole undergoing a drilling operation, wherein the input parameters include user parameters and received subterranean formation characteristics received from one or more sensors, (2) generating transformed subterranean formation characteristics by transforming the received subterranean formation characteristics representing rock stress to a coordinate system, (3) calculating subterranean formation parameters using the transformed subterranean formation characteristics and the received subterranean formation characteristics, (4) applying a lithology-specific algorithm to the subterranean formation parameters to generate a failure criterion, (5) performing a caving analysis using the failure criterion and the received subterranean formation characteristics to determine a caving volume or a caving probability, and (6) communicating the caving volume or the caving probability to a drilling controller of the borehole.
B. A system, including (1) a data transceiver, capable of receiving input parameters for a borehole undergoing a drilling operation, wherein the input parameters include user parameters and subterranean formation characteristics received from one or more sensors located downhole the borehole or located at surface locations proximate the borehole, and (2) a caving analyzer, capable of communicating with the data transceiver, generating transformed subterranean formation characteristics by transforming a portion of the subterranean formation characteristics that relate to rock stress to a coordinate system, calculating subterranean formation parameters using the transformed subterranean formation characteristics, applying a lithology-specific algorithm to the subterranean formation parameters to generate a failure criterion, performing a caving analysis using the failure criterion on the subterranean formation characteristics to determine a caving volume or a caving probability, and communicate the caving volume or caving probability to a drilling operation controller.
C. A computer program product having a series of operating instructions stored on a non-transitory computer-readable medium that directs a data processing apparatus when executed thereby to perform operations to determine a caving volume or a caving probability, the operations including (1) receiving input parameters for a subterranean formation proximate a borehole undergoing a drilling operation, wherein the input parameters include user parameters and received subterranean formation characteristics received from one or more sensors, (2) generating transformed subterranean formation characteristics by transforming the received subterranean formation characteristics representing rock stress to a coordinate system, (3) calculating subterranean formation parameters using the transformed subterranean formation characteristics and the received subterranean formation characteristics, (4) applying a lithology-specific algorithm to the subterranean formation parameters to generate a failure criterion, (5) performing a caving analysis using the failure criterion and the received subterranean formation characteristics to determine the caving volume or the caving probability, and (6) communicating the caving volume or the caving probability to a drilling controller of the borehole.

Each of the disclosed aspects in A, B, and C can have one or more of the following additional elements in combination. Element 1: wherein the coordinate system is a Cartesian coordinate system or a cylindric coordinate system. Element 2: wherein a portion of the received subterranean formation characteristics representing a radial distance layer is utilized. Element 3: wherein the calculating, applying, and performing are repeated for each successive radial distance layer from an inner surface of the borehole to a maximum specified distance. Element 4: wherein the radial distance layer is incremented by a distance increment multiplied by a radius of the borehole. Element 5: wherein the maximum specified distance is a radius of the borehole times one or more. Element 6: wherein the lithology-specific algorithm is a Mogi-Coulomb failure criterion when the received subterranean formation characteristics indicate a carbonate rock. Element 7: wherein the lithology-specific algorithm is a Mohr-Coulomb failure criterion when the received subterranean formation characteristics indicate a sandstone or a shale rock. Element 8: wherein the generating calculates a principal stress by subtracting from the rock stress a result of a Biot's coefficient multiplied by a pore pressure derived from the received subterranean formation characteristics. Element 9: wherein the rock stress is one or more of a vertical stress parameter, a minimum horizontal stress parameter, a maximum horizontal stress parameter, an inclination parameter, an azimuth parameter, or an orientation of the maximum horizontal stress parameter. Element 10: wherein the subterranean formation parameters are one or more of a rock strength, a Poisson's ratio, a porosity, a density, or a friction angle. Element 11: wherein the received subterranean formation characteristics are determined from real-time or near real-time data collected by downhole sensors or at a surface location proximate the borehole. Element 12: wherein the received subterranean formation characteristics are received and correlated from data received from one or more of a previous sensor collection in the borehole, a proximate borehole, a laboratory, a data store, a cloud environment, or a computing system. Element 13: wherein the generating, calculating, applying, and performing are repeated at more than one measured depth layer of a depth interval, where the measured depth layer is incremented by a measured depth increment until an end state is satisfied. Element 14: wherein the end state is when a maximum depth layer is exceeded, or a measured depth interval of interest for analysis is reached. Element 15: wherein the caving volume determined at each performing are added together to obtain a measured depth caving volume for the depth interval. Element 16: wherein at each radial distance layer, a breakout angle is calculated utilizing the transformed subterranean formation characteristics and a failure criteria. Element 17: wherein the performing is applied to a restricted set of angles radially arranged from a center point of the borehole. Element 18: wherein the restricted set of angles are perpendicular to an inner surface of the borehole. Element 19: wherein the restricted set of angles is 0.0 to 180.0 degrees with a direct symmetry calculation or 0.0 to 360.0 degrees, from a specified starting point. Element 20: further including modifying a drilling operation plan using the caving volume or the caving probability. Element 21: further including a machine learning system, capable of communicating with the caving analyzer and to perform the calculating, applying, and performing of the caving analyzer. Element 22: further including a result transceiver, capable of communicating the caving volume or the caving probability and interim outputs to a user system, a data store, a computing system, or a drilling controller. Element 23: wherein the drilling controller is one of a geo-steering system, a mud pump, a rig controller, a drilling assembly, a well site controller, the computing system, or a drilling operation system.

What is claimed is:

1. A method, comprising:
receiving input parameters for a subterranean formation proximate a borehole undergoing a drilling operation, wherein the input parameters include user parameters and received subterranean formation characteristics received from one or more sensors;
generating transformed subterranean formation characteristics by transforming the received subterranean formation characteristics representing rock stress to a coordinate system;
calculating subterranean formation parameters using the transformed subterranean formation characteristics and the received subterranean formation characteristics;
applying a lithology-specific algorithm to the subterranean formation parameters to generate a failure criterion;
performing a caving analysis using the failure criterion and the received subterranean formation characteristics to determine a caving volume or a caving probability; and
communicating the caving volume or the caving probability to a drilling controller of the borehole.

2. The method as recited in claim 1, wherein the coordinate system is a Cartesian coordinate system or a cylindric coordinate system.

3. The method as recited in claim 1, wherein a portion of the received subterranean formation characteristics representing a radial distance layer is utilized and the calculating, applying, and performing are repeated for each successive radial distance layer from an inner surface of the borehole to a maximum specified distance.

4. The method as recited in claim 3, wherein the radial distance layer is incremented by a distance increment multiplied by a radius of the borehole.

5. The method as recited in claim 3, wherein the maximum specified distance is a radius of the borehole times one or more.

6. The method as recited in claim 1, wherein the lithology-specific algorithm is a Mogi-Coulomb failure criterion when the received subterranean formation characteristics indicate a carbonate rock.

7. The method as recited in claim 1, wherein the lithology-specific algorithm is a Mohr-Coulomb failure criterion when the received subterranean formation characteristics indicate a sandstone or a shale rock.

8. The method as recited in claim 1, wherein the generating calculates a principal stress by subtracting from the rock stress a result of a Biot's coefficient multiplied by a pore pressure derived from the received subterranean formation characteristics.

9. The method as recited in claim 1, wherein the rock stress is one or more of a vertical stress parameter, a minimum horizontal stress parameter, a maximum horizontal stress parameter, an inclination parameter, an azimuth parameter, or an orientation of the maximum horizontal stress parameter.

10. The method as recited in claim 1, wherein the subterranean formation parameters are one or more of a rock strength, a Poisson's ratio, a porosity, a density, or a friction angle.

11. The method as recited in claim 1, wherein the received subterranean formation characteristics are determined from real-time or near real-time data collected by downhole sensors or at a surface location proximate the borehole.

12. The method as recited in claim 1, wherein the received subterranean formation characteristics are received and correlated from data received from one or more of a previous sensor collection in the borehole, a proximate borehole, a laboratory, a data store, a cloud environment, or a computing system.

13. The method as recited in claim 1, wherein the generating, calculating, applying, and performing are repeated at more than one measured depth layer of a depth interval, where the measured depth layer is incremented by a measured depth increment until an end state is satisfied.

14. The method as recited in claim 13, wherein the end state is when a maximum depth layer is exceeded, or a measured depth interval of interest for analysis is reached.

15. The method as recited in claim 13, wherein the caving volume determined at each performing are added together to obtain a measured depth caving volume for the depth interval.

16. The method as recited in claim 13, wherein at each radial distance layer, a breakout angle is calculated utilizing the transformed subterranean formation characteristics and a failure criteria.

17. The method as recited in claim 16, wherein the performing is applied to a restricted set of angles radially arranged from a center point of the borehole, where the restricted set of angles are perpendicular to an inner surface of the borehole.

18. The method as recited in claim 17, wherein the restricted set of angles is 0.0 to 180.0 degrees with a direct symmetry calculation or 0.0 to 360.0 degrees, from a specified starting point.

19. The method as recited in claim 1, further comprising:
modifying a drilling operation plan using the caving volume or the caving probability.

20. A system, comprising:
a data transceiver, capable of receiving input parameters for a borehole undergoing a drilling operation, wherein the input parameters include user parameters and subterranean formation characteristics received from one or more sensors located downhole the borehole or located at surface locations proximate the borehole; and
a caving analyzer, capable of communicating with the data transceiver, generating transformed subterranean formation characteristics by transforming a portion of the subterranean formation characteristics that relate to rock stress to a coordinate system, calculating subterranean formation parameters using the transformed subterranean formation characteristics, applying a lithology-specific algorithm to the subterranean formation parameters to generate a failure criterion, performing a caving analysis using the failure criterion on the subterranean formation characteristics to determine a caving volume or a caving probability, and communicate the caving volume or caving probability to a drilling operation controller.

21. The system as recited in claim 20, further comprising:
a machine learning system, capable of communicating with the caving analyzer and to perform the calculating, applying, and performing of the caving analyzer.

22. The system as recited in claim 20, further comprising:
a result transceiver, capable of communicating the caving volume or the caving probability and interim outputs to a user system, a data store, a computing system, or a drilling controller.

23. The system as recited in claim 22, wherein the drilling controller is one of a geo-steering system, a mud pump, a rig controller, a drilling assembly, a well site controller, the computing system, or a drilling operation system.

24. A computer program product having a series of operating instructions stored on a non-transitory computer-readable medium that directs a data processing apparatus when executed thereby to perform operations to determine a caving volume or a caving probability, the operations comprising:
receiving input parameters for a subterranean formation proximate a borehole undergoing a drilling operation, wherein the input parameters include user parameters and received subterranean formation characteristics received from one or more sensors;
generating transformed subterranean formation characteristics by transforming the received subterranean formation characteristics representing rock stress to a coordinate system;
calculating subterranean formation parameters using the transformed subterranean formation characteristics and the received subterranean formation characteristics;
applying a lithology-specific algorithm to the subterranean formation parameters to generate a failure criterion;
performing a caving analysis using the failure criterion and the received subterranean formation characteristics to determine the caving volume or the caving probability; and
communicating the caving volume or the caving probability to a drilling controller of the borehole.
